(19) United States
(12) Patent Application Publication
(10) Pub. No.: US 2011/0248503 A1
(43) Pub. Date: Oct. 13, 2011

(54) Wave driven pump and power generation system

(76) Inventor: George A. Ventz, Surf City, NJ (US)

(21) Appl. No.: 12/804,204

(22) Filed: Jul. 14, 2010

Related U.S. Application Data
(60) Provisional application No. 61/270,939, filed on Jul. 15, 2009.

(51) Int. Cl. F03B 13/18

(52) U.S. Cl. 290/53; 60/497; 60/504

(57) ABSTRACT

A piston pump is anchored to the ocean floor with the piston rod connected to a float that rides on the surface waves. The pump connects to a sparge line that discharges a spray of water through the float to indicate proper pump function. The float is formed with a conical upper portion and a conical lower portion and has an annular resilient rim. An array of pumps sends water under pressure through an aquaduct to an onshore electric power generation station, optionally including a reservoir. Water is returned from the generation station to the vicinity from which it was pumped.

### RELATED APPLICATION

This application is a conversion of provisional patent application No. 61/270,939 filed Jul. 15, 2009.

### FIELD OF THE INVENTION

The present invention relates to the field of power generation, and more particularly to a system for using wave motion to operate a pump for storing energy and providing water to generate electric power hydroelectrically.

### BACKGROUND OF THE INVENTION

The world demand for electric power increases continuously, partly because science and engineering develop more and better devices that rely on electricity, and partly because the world population grows every year. Most of the currently available electric power is generated by combustion of fossil fuels, i.e. oil, coal and natural gas. Burning these fuels presents two serious problems:

1) the supply of fossil fuel is not endless and will, in the foreseeable future, be depleted, and
2) the by-products of this burning pollute the atmosphere and have been found to cause climate change that is likely to be permanent.

To reduce the use of fossil fuels, several alternate technologies have been developed, or are in the process of development. The oldest alternate technology is the generation of electricity through hydroelectric plants, mainly used in active rivers with natural or man-made waterfalls. Hydroelectric power is efficient and safe, but limited by the dependence on an adequately strong river flow. Another technology is nuclear. Nuclear power, while subjected to several major failures in the early years of development, is reasonably safe today. However, nuclear involves the use of fissionable material, similar to the explosive and radioactive material of atomic bombs, and retains an unfavorable public image. A more recent technology for the generation of electricity is the use of modern windmills. Wind generated electric power has two main drawbacks, the public has objected to the appearance of a large number of windmills, and the wind is not consistent. Another recent technology is solar photovoltaic generation that, while not known to be a danger, is subject to sunlight that is at best available for twelve hours on a clear day.

The most recent technological area under development for the generation of electric power is harnessing the forces of the ocean waves. Many projects are currently being pursued in this field. The known systems using wave power to generate electricity are either susceptible to damage in a storm or potentially injurious to local fauna by transmitting electric power generated at sea through a submerged cable. A further hazard to the environment caused by certain wave driven electric generation systems is changing the water conditions by pumping water from an offshore site to a land-based turbine generator and discharging the water close to the generator. This inserts water of different temperature, and possibly different chemical content, into a sensitive area.

### SUMMARY OF THE INVENTION

The present invention defines a novel and efficient apparatus for generation of electric power using wave, floatation in a design that is highly resistant to storm damage and environmentally benign. A pump is driven by a float buoyed by the rise and fall of the wave cycle. The pump anchored offshore sends a flow of pressurized ocean water through an aquaduct to an onshore station for generating electric power. After driving the generating turbines, the ocean water is returned to the vicinity of the pump. An array of many pumps and floats is assembled to provide an adequate supply of pressurized ocean water to generate a substantial amount of electric power. The float is configured to optimize floatation while allowing complete submersion during storms, avoiding significant damage to the system. Operational indication for each pump is provided with a sparge line. Certain pump components are able to be serviced and maintained from above at the ocean surface.

### BRIEF DESCRIPTION OF THE DRAWINGS

The present invention is best understood in conjunction with the accompanying drawing figures in which like elements are identified by similar reference numerals and wherein:

FIG. 1 is a side elevation schematic of a pump and float installed offshore and a reservoir and power generation station installed onshore according to the present invention.

FIG. 2 shows a pair of adjacent float and pump sets being driven by the rise and fall of waves.

FIG. 3 is a schematic diagram of an array of floats and pumps connected into an aquaduct manifold.

FIG. 4 is a side elevation view of a pump and anchor according to the invention.

FIG. 5 is a detail of the upper portion of the pump of FIG. 5 with the piston thereof at the top of a stroke.

FIG. 6A is a top plan view of a typical float according to the invention.

FIG. 6B is a side elevation view of the float of FIG. 6A.

FIG. 7A is a top plan view of a core for the float of FIG. 6A.

FIG. 7B is a side elevation view of the core of FIG. 7A.

### DETAILED DESCRIPTION OF THE PREFERRED EMBODIMENT

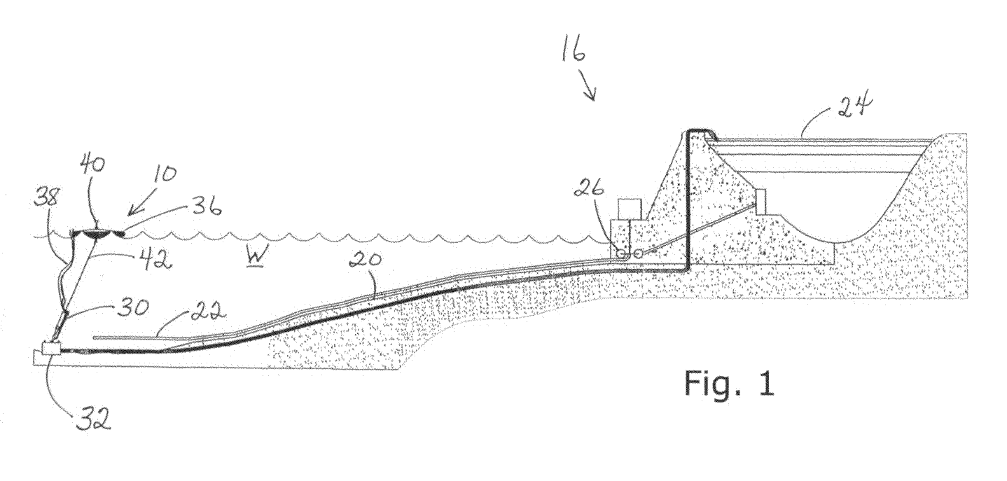

Referring to FIG. 1, a side elevation of the invention wave driven pump 30 and power generation station 16 is depicted installed in an ocean near the shoreline. As discussed above, an ocean site is preferred to harness the substantially continuous wave activity in driving the pump that is the central element of the present invention. However, it is recognized that major lakes also have significant wave action, therefore the term ocean is used in the context to include all bodies of water having fairly regular wave activity. A pumping station 10 is installed a distance from the shore where the water is of sufficient depth for proper pump operation, e.g. approximately seventy-five feet deep. A power generation station 16 is installed on shore to receive a flow of pressurized water from pump 30 through pipe 20. Power generation station 16 may be located adjacent to the ocean shore or farther inland, depending on the topography and local regulations, etc.

Referring further to FIG. 1, pumping station 10 consists of pump 30 that is held securely in position by an anchor 32. Pump 30 is of the linear piston and cylinder type adapted for operation in an ocean environment. A float 36 is connected to pump 30 by a cable 42. A beacon 40 is mounted on float 36 to function both as a warning and as a position indicator to ships in the area. As will be discussed in detail below, pumping station 10 is an individual component within an array of many such pumping stations. Float 36 rises and falls with the oscillating motion of the ocean waves, alternately applying and releasing tension to cable 42 that cyclically drives the piston in pump 30. It will be understood that in order for the submerged pump to be monitored, an indication of proper pump function is needed. For this purpose, a sparge line 38 is connected between pump 30 and the ocean surface. Sparge line 38 receives a small flow of water when pump 30 is pressurized and discharges a water spray adjacent to float 36 to inform maintenance personnel that this pumping station 10 is operating.

Continuing with FIG. 1, power generation station 16 may optionally include a reservoir 24 where the ocean water is pumped and stored for use to generate additional power during periods of high demand. The ocean water is conducted to drive a turbine that drives an electric generator 26, as is well known. The ocean water exiting from the electric generator 26 passes through a return line 22 to be discharged in the same vicinity of the ocean from which it was taken, i.e. adjacent to the array of pumping stations 10. It is noted that the ocean water is not modified chemically or thermally during the process described, and therefore returning the water to the vicinity of initial collection after driving the generating turbines causes the least environmental disturbance.

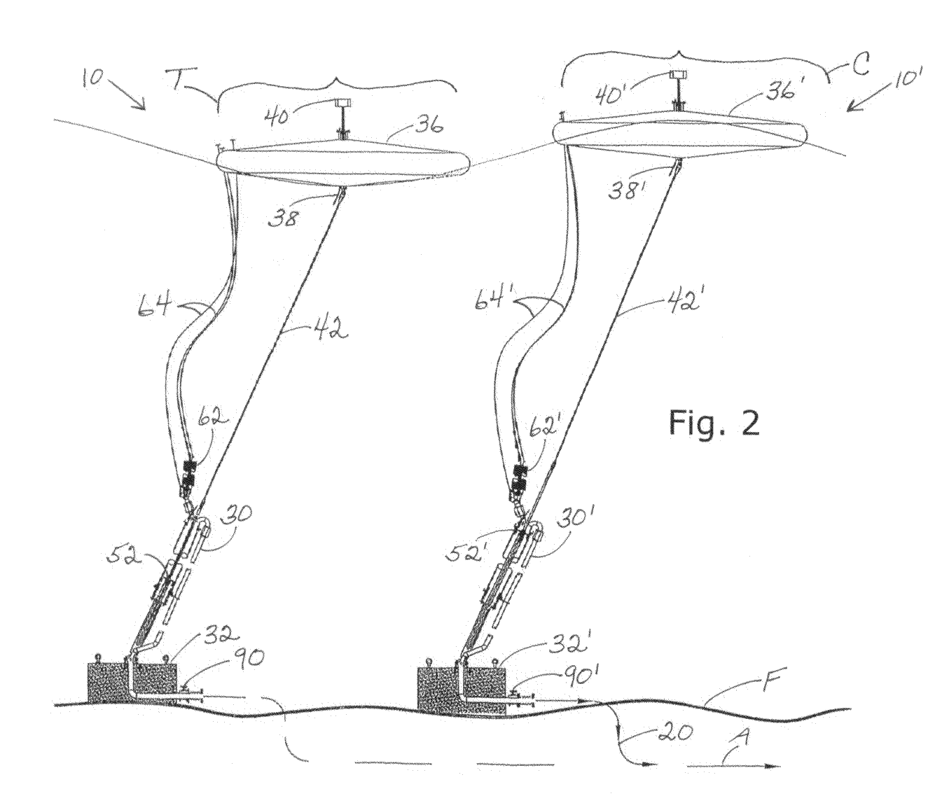

Referring now to FIG. 2, a pair of adjacent pumping stations 10 and 10′ are shown in side elevation view. Pumping station 10 has a float 36 located at a wave trough T, and pumping station 10′ has a float 36′ located at a wave crest C. Anchors 32, 32′ are resting on the ocean floor F. Floats 36, 36′ are not located directly above pumps 30, 30′ and anchors 32, 32′ due to the action of a typical ocean current, and cables 42, 42′ are respectively angled in the flow direction of the current. With float 36 in a wave trough T being relatively lower, cable 42 is relatively relaxed and piston 52 in pump 30 is at the bottom of the stroke. Conversely, with float 36′ on a wave crest C and being relatively higher, cable 42′ is relatively tense and piston 52′ in pump 30′ is at the top of the stroke. Therefore, pump 30′ is discharging a flow of pressurized water through exit valve 90′ into pipe 20 as indicated by arrows A. Pump 30 is not actively discharging water at this cycle point.

Referring further to FIG. 2, sparge line 38 connects from pump 30 to float 36, and sparge line 38′ connects from pump 30′ to float 36′, with a function status confirming discharge of water shown spraying from sparge line 38′. A sparge line 38 from each submerged pump 30 to the ocean surface provides an effective indicator of function status for each pump. In order to minimize the inflow of particulate that might affect the operation of pumps 30, 30′, filters 62, 62′ are mounted to pumps 30, 30′ respectively. A service line 64, 64′ is connected to each filter 62, 62′ to enable a maintenance person at the ocean surface to change the filter when needed without diving. Beacons 40, 40′ preferably include a lighted signal that is powered by a photovoltaic panel, as well as reflective panels, as are known.

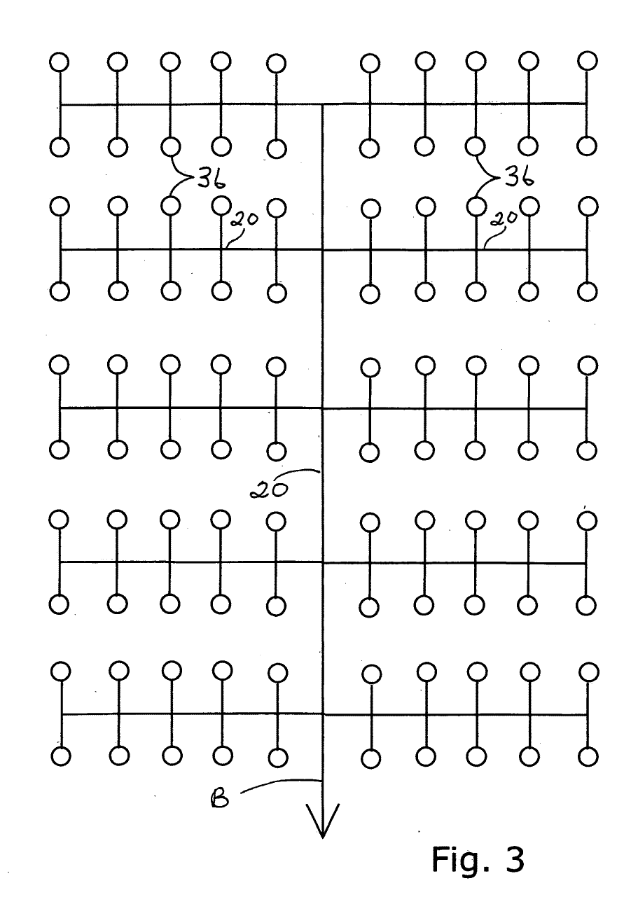

Referring now to FIG. 3, one embodiment of an array of pump floats 36 is illustrated in plan view. Each of the pumps attached to floats 36 is connected to discharge pressurized ocean water through a pipe 20 which flows in the direction indicated by arrow B to deliver pressurized water to generating station 16 (see FIG. 1). Floats 36 reside on the surface of the water and pipes 20 reside on the ocean floor. While floats 36 are illustrated as being vertically over the pumps connected thereto, floats 36 are intended to move in the direction of the ocean current flow. It is believed to be advantageous to orient the array of floats in a manner to minimize the “shadow” effect caused by a first float being aligned with a second float along the path of the ocean current. Due to the flexible tethering of each float, the float is able to move with respect to the pump to which it is attached. The ocean currents vary according to climatic conditions. Therefore, no specific float array configuration can be significantly less susceptible to the “shadow” effect than any other configuration.

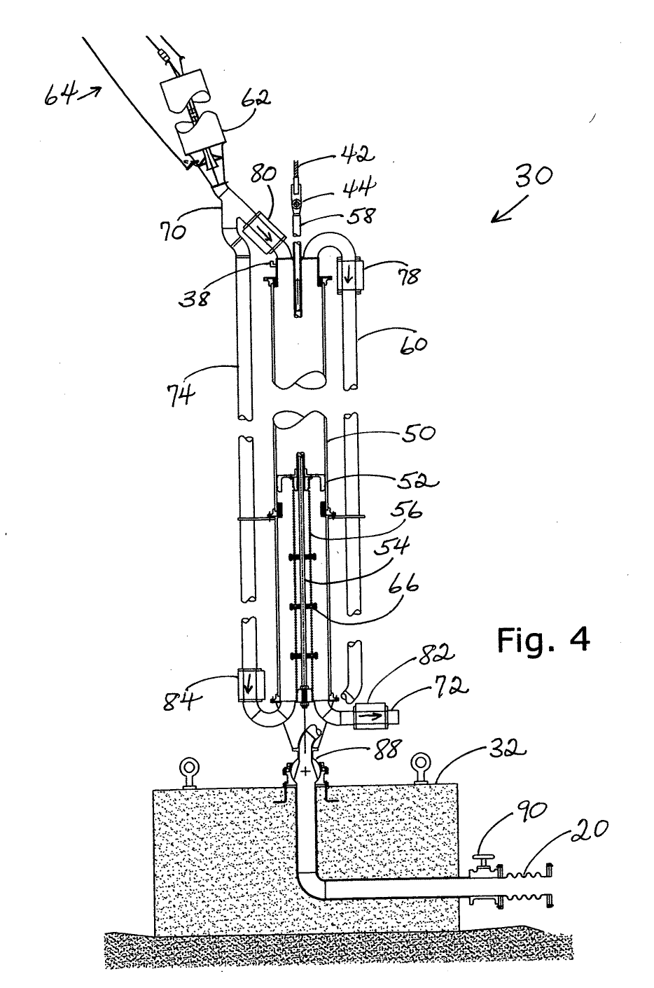

Referring now to FIG. 4, an enlarged side elevation view of pump 30 is shown to disclose additional details. Pump 30 is mounted to anchor 32 by means of a swivel connector 88, enabling pump 30 to move in response to currents in the ocean without damage. A number of eyebolts are mounted on anchor 32 to allow anchor 32 to be formed on the land surface adjacent to the ocean and lowered into position in the array discussed above. Output flow from pump 30 passes through a valve 90 into a pipe 20. Valve 90 is provided to enable a single pump 30 to be isolated from the system for replacement or maintenance operations. The upper portion of a tube 58 is connected to the lower portion of cable 42 by a swivel connector 44, the upper portion of cable 42 being connected to float 36 (see FIG. 2).

Referring further to FIG. 4, when float 36′ (see FIG. 2) is raised by the action of ocean waves, cable 42 pulls upward axially on tube 58. The lower end of tube 58 is fixedly connected to piston 52, pulling piston 52 up within cylinder 50. A solid rod 54 is affixed to the bottom of cylinder 50 and extends through piston 52 and a portion of tube 58 to terminate a small distance below the upper end of cylinder 50. Rod 54 functions as a guide for smooth movement of piston 52 and tube 58. An extension spring 56 is affixed to the bottom of piston 52 and the bottom end of cylinder 50. As cable 42 pulls tube 58 and piston 52 upward, spring 56 extends. A series of stabilizers 66 for spring 56 are fixedly mounted at intervals to rod 54 to dampen harmonic vibrations that may occur in spring 56.

Continuing with FIG. 4, the flow of water is controlled by a series of check valves. Check valves allow liquid flow in one direction only, the direction being indicated by the respective arrow shown in the check valve noted. All water enters the system through filter 62 and into top inlet “Y” connector 70. When piston 52 is moving upward, a partial vacuum is generated below piston 52 and water flows through inlet pipe 74 and check valve 84 to the chamber below piston 52. The upward moving piston 52 forces pressurized water out through check valve 78 and pipe 60, through valve 90 and into discharge pipe 20. When piston 52 is moving downward under the force exerted by spring 56, water enters the system through filter 62 and top inlet “Y” connector 70, through top inlet check valve 80 into the chamber above piston 52. Simultaneously, water from the chamber below piston 52 is driven by the action of spring 56 out through check valve 82 into discharge pipe 72.

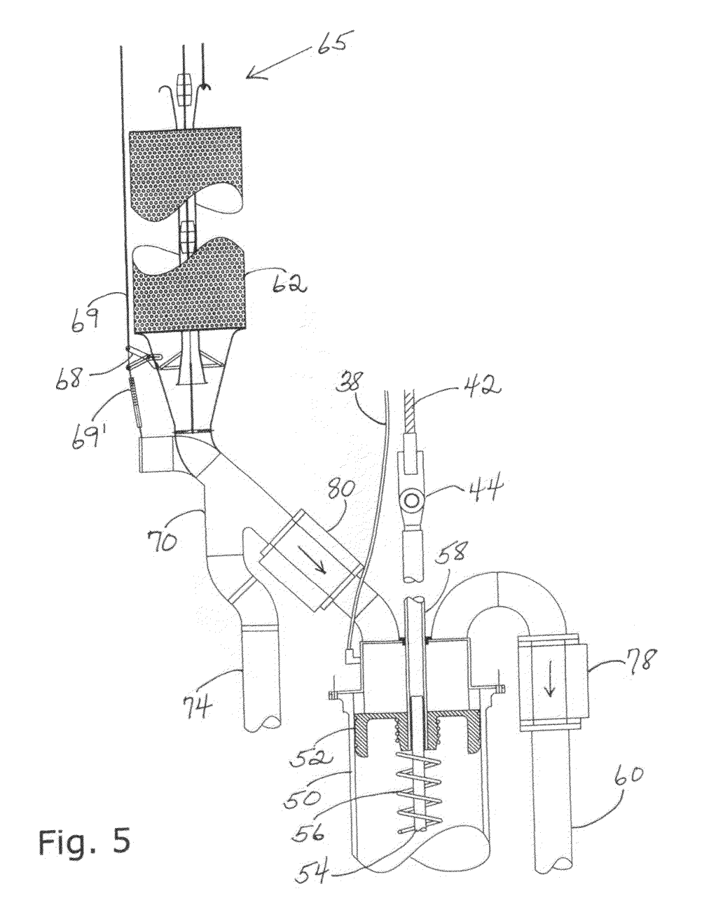

Referring now to FIG. 5, an enlarged partial cross sectional view of the upper portion of the pump mechanism is shown. Filter 62 is affixed to “Y” connector 70 by a latch 68. When filter 62 is in need of replacement, evidenced by a major reduction of flow from the related sparge line 38, a maintenance person at the ocean surface pulls cord 69 against the tension of spring 69′ to open latch 68 and release filter 62. Lines 65, fitted over pulleys in the manner of a drapery cord or clothes line, is pulled to move used filter 62 up to the water surface. Used filter 62 is then removed from lines 65 and a new filter 62 put in its place and lowered into position on “Y” connector 70. Latch 68 snaps closed to engage new filter 62 by the action of lines 65.

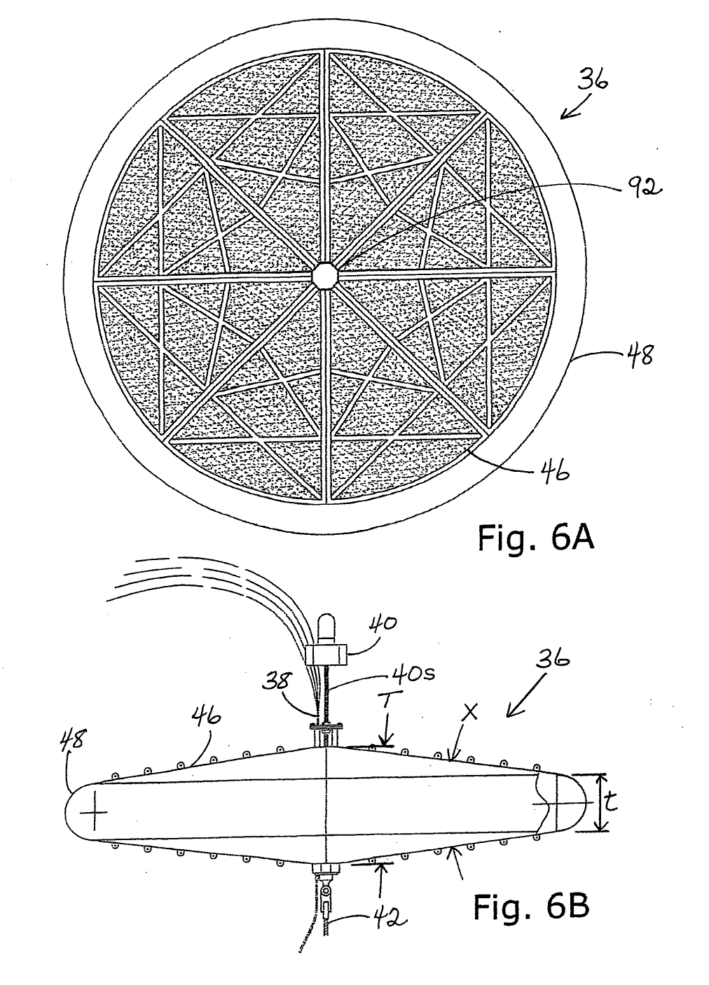

Referring now to FIGS. 6A and 6B, a float 36 according to the present invention is shown in top plan view and side elevation view, respectively. Float 36 has an annular rim 48 that is formed of a resilient material with a specific gravity less than 1.0 to enhance floatation. Float 36 has a central core 92 that is substantially octagonal in top plan view. A series of eight segments 46 are formed individually with a thickness t at an outer edge thereof, thickness t being substantially equal to the thickness of rim 48. Segments 46 are each produced by forming a grid framework to be filled with a closed cell foam material that is resistant to sun and salt water degradation. The foam material also has a specific gravity less than 1.0. The central apex of each segment 46 has a thickness T that is substantially equal to the height of core 92. As illustrated, thickness T is significantly greater than thickness t, giving float 36 a double conical cross sectional shape. The double cone angle “X” formed is preferably between approximately 10° and 50°. The double conical cross sectional shape in combination with the circular top plan view has been determined to provide a durable and highly functional float device that is resistant to storm damage and will not be harmed by being submerged during a storm surge. Additional cross sectional shapes providing a tapered lower part, e.g. ellipses, are considered within the scope of the present invention. Beacon 40 appears on support stalk 40s as described above. Beacon 40 has plural reflective surfaces for daytime signaling and a solar powered battery to operate a light for nighttime visibility.

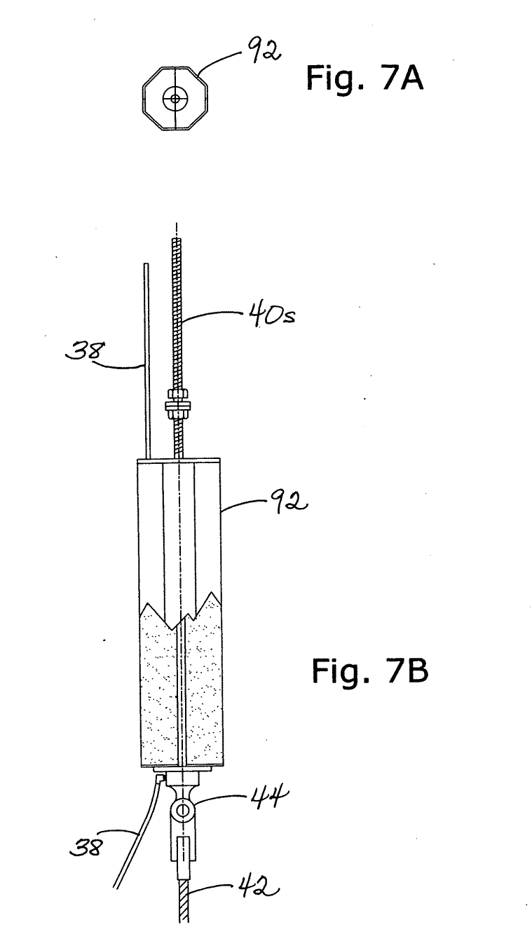

Referring now to FIGS. 7A and 7B, core 92 is shown in top plan view and broken side elevation view as it appears prior to assembly in the float described above. The lower end of core 92 is mounted to cable 42 by swivel connector 44. Core 92 is formed with plural planar exterior faces, in the preferred embodiment being eight faces, to receive eight segments 46 of float 36 (see FIG. 6A). Sparge line 38 passes from the bottom of core 92 therethrough and exits the top of core 92 to discharge a spray of water, indicating that the attached pump is functioning properly. When a sparge line 38 is observed by maintenance personnel to have a weak spray or no spray, corrective action is needed, most likely a filter replacement.

As the wave driven pump and power generation system of the invention are contemplated to operate in a salt water environment and be exposed to direct sunlight and temperature extremes, all components are made of weather and ultraviolet resistant plastic resin or 316 stainless steel. In the preferred embodiment of the system, the piston is approximately twenty-four (24) inches in diameter, having a stroke length of ninety-six (96) inches. The extension spring is formed of a five-eighths (⅝) inch diameter wire with an outside spring diameter of 7.25 inches and a compressed length of approximately sixty (60) inches. It will be understood that the additional length needed to enclose the extension spring within the cylinder requires the overall cylinder length to be approximately one hundred fifty six (156) inches. It will be understood that due to the variation in wave magnitude, the actual stroke of the piston will vary. The float used to operate the pump described is approximately thirty (30) feet in diameter.

Assuming an average wave height from trough to crest of thirty-six (36) inches and a frequency of ten (10) wave cycles per minute, total output from each pump in the system is calculated to be approximately 102 horsepower, equaling 76 kilowatts of electric power per pump. With an array of one thousand (1000) pumps, a total of 76 megawatts (less transmission losses) of electric power is anticipated.

While the description above discloses preferred embodiments of the present invention, it is contemplated that numerous variations and modifications of the invention are possible and are considered to be within the scope of the claims that follow.

What is claimed is:

1. A wave driven pump, comprising:
a. a cylinder;
b. a piston slidingly contained within the cylinder;
c. biasing means connected to the piston within the cylinder to urge the piston down;
d. a float located outside of the cylinder at the surface of an ocean and connected to the piston;
e. wherein the cylinder is connected to an anchor in a body of water in which waves occur such that the float moves the piston up within the cylinder when a wave lifts the float and the biasing means moves the piston down when the wave allows the float to be lowered; and
f. means connected to the pump for remotely indicating the function status of the pump.

2. The wave driven pump described in claim 1, wherein the float is connected to the piston through a flexible coupling.

3. The wave driven pump described in claim 1, wherein the pump is connected to the anchor through a flexible coupling.

4. The wave driven pump described in claim 1, wherein the means for remotely indicating the function status of the pump comprises a sparge line connected at a first end thereof to the pump and at a second end to discharge water adjacent to the float.

5. The wave driven pump described in claim 1, wherein the float comprises a buoyant rim.

6. The wave driven pump described in claim 1, wherein the float is formed with a double conical cross sectional shape.

7. The wave driven pump described in claim 6, wherein the angle between the top cone edge and the bottom cone edge is between approximately 10° and 50°.

8. The wave driven pump described in claim 1, further comprising a filter in fluid connection with the cylinder.

9. The wave driven pump described in claim 8, wherein water entering the cylinder above the piston and water entering the cylinder below the piston all pass through the filter.

10. The wave driven pump described in claim 8, wherein the filter is mounted to an inlet of the pump in a manner to enable remotely removing the filter and replacing the removed filter with a new filter.

11. The wave driven pump described in claim 1, further comprising a guide rod positioned within the cylinder to allow the piston to slide therealong.

12. The wave driven pump described in claim 1, wherein the biasing means comprises an extension spring.

13. An electric power generating system, comprising:
a. an array of pumping stations located offshore, each pumping station having a linear pump;
b. a float positioned above each pump to rise and fall with wave action;
c. means for connecting between each float and each respective pump;
d. a generating station located onshore;
e. a pressurized aquaduct having a first end in fluid communication with an output of each pump and a second end in fluid communication with an input of the generating station; and
f. a return aquaduct connected at a first end to an output of the generating station and at a second end adjacent to the array of pumping stations for returning the water from the generating station to the offshore location of the pumps.

14. The electric power generating system described in claim 13, further comprising means connected to each pump in the array of pumping stations for remotely indicating the function status of each pump.

15. The electric power generating system described in claim 14, wherein the means connected to each pump in the array of pumping stations for remotely indicating the function status of each pump comprises a sparge line connected at a first end thereof to the pump and at a second end to discharge water adjacent to the float.

16. The electric power generating system described in claim 13, further comprising a reservoir located onshore higher than the generating station to receive water from the pressurized aquaduct and provide the water to the generating station.
